(19) United States
(12) Patent Application Publication
(10) Pub. No.: US 2006/0017785 A1
(43) Pub. Date: Jan. 26, 2006

(54) Ink jet head including a filtering member integrally formed with a substrate and method of fabricating the same

(76) Inventors: Yong-Shik Park, Seongnam-si (KR); Kwang-Ryul Kim, Suwon-si (KR); Kyong-Il Kim, Seoul (KR)

Correspondence Address: STANZIONE & KIM, LLP, 919 18TH STREET, N.W., SUITE 440, WASHINGTON, DC, 20006, US

(21) Appl. No.: 11/185,764

(22) Filed: Jul. 21, 2005

(30) Foreign Application Priority Data
Jul. 23, 2004 (KR) 2004-57854

(51) Int. Cl. B41J 2/05

(52) U.S. Cl. 347/61

(57) ABSTRACT

An ink jet head having a filtering member integrally formed with a substrate and method of fabricating the same are provided. The ink jet head includes a plurality of pressure-generating elements disposed on a substrate to generate pressure to provide ink ejection. An ink-feed passage extending through the substrate is disposed to be spaced apart from the pressure-generating elements. A manifold recessed from a top surface of the substrate by a predetermined depth and having a width defined by the ink-feed passage is disposed between the pressure-generating elements and the ink-feed passage. A plurality of filtering pillars is disposed on a bottom surface of the manifold to provide filter openings therebetween. The filtering pillars are integrally formed with the substrate. A flow path structure defining a flow path is disposed on the top surface of the substrate, wherein the flow path includes ink chambers that contain the pressure-generating elements therein, ink channels that open the ink chambers toward a direction of the manifold, and nozzles that are in fluid communication with the ink chambers.

### CROSS-REFERENCE TO RELATED APPLICATIONS

This application claims the benefit of Korean Patent Application No. 2004-57854, filed Jul. 23, 2004, the disclosure of which is hereby incorporated herein by reference in its entirety.

### BACKGROUND OF THE INVENTION

1. Field of the Invention

The present general inventive concept relates to an ink jet head and a method of fabricating the same and, more particularly, to an ink jet head including a filtering member integrally formed with a substrate and a method of fabricating the same.

2. Description of the Related Art

An ink jet recording device prints images by ejecting fine droplets of ink to a desired position on a recording medium. Ink jet recording devices have been widely used due to their inexpensive price and their capability of printing numerous colors at a high resolution. The ink jet recording device includes an ink jet head for actually ejecting ink, and an ink container in fluid communication with the ink jet head. The ink jet head can be classified based on a pressure-generating element used for ink ejection as a thermal type that uses an electro-thermal transducer, or a piezo-electric type that uses an electro-mechanical transducer.

The ink jet head includes a silicon substrate having a chip shape, and a number of components disposed on a top surface of the silicon substrate. An example of a thermal ink jet head is disclosed in U.S. Pat. No. 4,882,595. The thermal ink jet head has a plurality of heat-generating resistors disposed on the silicon substrate to generate pressure for ink ejection, a chamber layer for defining a sidewall of an flow path including an ink chamber and an ink channel, and a nozzle layer disposed on the chamber layer. The nozzle layer has a plurality of nozzles corresponding to each of the heat-generating resistors. A bottom surface of the silicon substrate is attached to the ink container, and the ink in the ink container is supplied to the ink jet head through an ink-feed passage passing through the silicon substrate. The ink is supplied through the ink-feed passage via the ink channel to the ink chamber, where it is temporarily stored. The ink stored in the ink chamber is instantly heated by the heat-generating resistor and is then ejected by the pressure generated onto the recording medium through the nozzle in a droplet shape. Then, the ink chamber is refilled with ink that flows through the ink channel.

Particles may be introduced into the flow path together with the ink. When the particles have a dimension that is larger than that of the flow path, the flow path may be clogged by the particles. This may cause a quality of printing to deteriorate. Further, if a particle clogs one of the nozzles, the ink may not be ejected from the nozzle. To prevent this problem, a mesh filter has been provided between the ink jet head and the ink container to prevent the particles from being introduced into the flow path from the ink container. However, a reduction of the ink droplet size is required for high resolution printing, and thus a dimension of the flow path is reduced. For this reason, use of the mesh filter is limited.

As a result, technologies relating to forming a filtering member on the silicon substrate during a process of fabricating the ink jet head have been researched. Ink jet heads provided with the filtering member are disclosed in U.S. Pat. Nos. 5,463,413 and 6,626,522.

FIG. 1 is a perspective view of a conventional ink jet head disclosed in U.S. Pat. No. 5,463,413.

Referring to FIG. 1, heat-generating resistors 3 are disposed on a substrate 1. A chamber layer 5 defining a flow path including ink chambers and ink channels is disposed on the substrate 1. A nozzle layer 7, which is provided with nozzles 7′ corresponding to each of the heat-generating resistors 3, is disposed on the chamber layer 5. An ink-feed passage 9 is disposed to pass through the substrate 1 at a portion spaced apart from the heat-generating resistors 3. Pillars 11 are disposed along the ink-feed passage 9 to prevent particles introduced through the ink-feed passage 9 from penetrating into the ink chamber. According to the U.S. Pat. No. 5,463,413, the pillars 11 are formed by the same process and are formed of the same material layer as the chamber layer 5. For example, the pillars 11 and the chamber layer 5 may be formed by forming a photosensitive resin layer on the substrate 1 and patterning the photosensitive resin layer using a photo process. Generally, the pillars 11 serve as a fluid resistor impeding flow of the ink in the flow path. Therefore, the pillars 11, which have small dimensions, are intended to prevent the particles from penetrating into the ink chamber. However, since the pillars 11 are formed by patterning the photosensitive resin layer as set forth above, there is a limit to reducing the dimension of the pillars 11. That is, considering that a thickness of the chamber layer 5 and a height of the ink chamber is greater than about 10 micrometers (μm), it may be difficult for the pillars 11 formed by the photo process to have an aspect ratio greater than about 1. Aspect ratio may be defined as a ratio of a height dimension to a width dimension. In addition, even if the pillars 11 are formed to have an aspect ratio greater than about 1, the pillars may be readily separated from the substrate 1 due to poor adhesive strength between the photosensitive resin layer and the substrate 1.

The conventional ink jet head having the pillars 11, as set forth above, decreases a speed with which the ink is refilled into the ink chamber after the ink ejection due to the pillars 11 providing fluid resistance. Thus, improvements in an ink ejection frequency may be limited.

### SUMMARY OF THE INVENTION

The present general inventive concept provides an ink jet head having a filtering member capable of preventing particles from penetrating into a flow path with a minimum fluid resistance.

The present general inventive concept also provides a method of fabricating an ink jet head having a filtering member.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an ink jet head having filtering pillars integrally formed with a substrate. The ink jet head includes a plurality of pressure-generating elements disposed on a substrate to generate pressure to provide ink ejection. An ink-feed passage extending through the substrate is disposed to be spaced apart from the pressure-generating elements. A manifold that is recessed from a top surface of the substrate by a predetermined depth and has a width defined by the ink-feed passage is disposed between the pressure-generating elements and the ink-feed passage. A plurality of filtering pillars is disposed on a bottom surface of the manifold to provide filter openings therebetween. The filtering pillars are integrally formed with the substrate. A flow path structure defining a flow path is disposed on the top surface of the substrate, wherein the flow path may include ink chambers that contain the pressure-generating elements therein, ink channels that open the ink chambers toward a direction of the manifold, and nozzles that are in fluid communication with the ink chambers.

The foregoing and/or other aspects and advantages of the present general inventive concept may also be achieved by providing a method of fabricating an ink jet head having a filtering member integrally formed with a substrate. The method includes forming a plurality of pressure-generating elements to generate pressure to provide ink ejection on a substrate. The substrate is patterned to form a trench spaced apart from the pressure-generating elements and defining a plurality of filtering pillars, the filtering pillars being spaced apart from sidewalls of the trench and being formed to provide filter openings therebetween. A flow path structure defining a flow path is formed on the substrate having the filtering pillars, wherein the flow path may include ink chambers that contain the pressure-generating elements therein, ink channels that open the ink chambers toward a direction of the trench, and nozzles that are in fluid communication with the ink chambers. The substrate may be etched to form an ink-feed passage extending through the bottom of the trench and to define a manifold including the filtering pillars.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a conventional ink jet head;

FIG. 2 is a perspective view of an ink jet head in accordance with an embodiment of the present general inventive concept;

FIG. 3 is a plan view of the ink jet head illustrated in FIG. 2;

FIGS. 4 to 9 are cross-sectional views, taken along the line I-I′ of FIG. 3, illustrating a method of fabricating an ink jet head in accordance with an embodiment of the present general inventive concept;

FIGS. 10 and 11 are cross-sectional views illustrating a method of fabricating an ink jet head in accordance with another embodiment of the present general inventive concept;

FIG. 12 is a plan view illustrating a relationship of a diameter of filtering pillars and filter openings;

FIGS. 13A and 13B are SEM images depicting filtering pillars in accordance with the present general inventive concept; and

FIGS. 14A and 14B are views representing computer simulation results that estimate ink ejection properties of an ink jet head depending upon a dimension of filtering pillars.

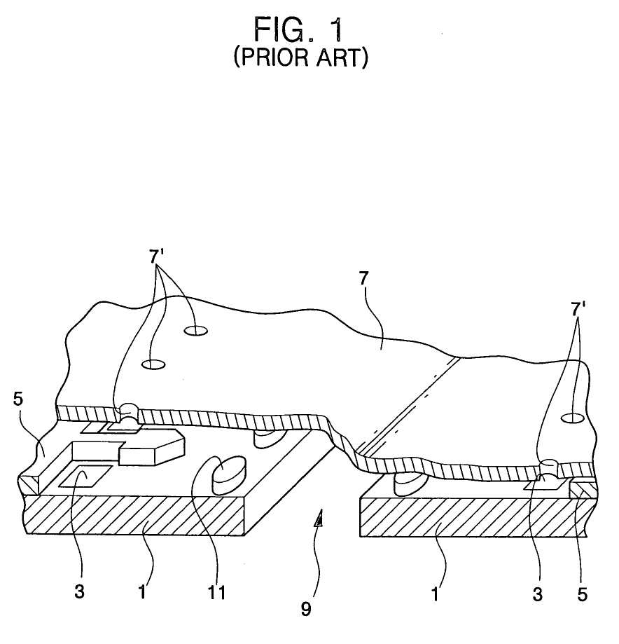

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

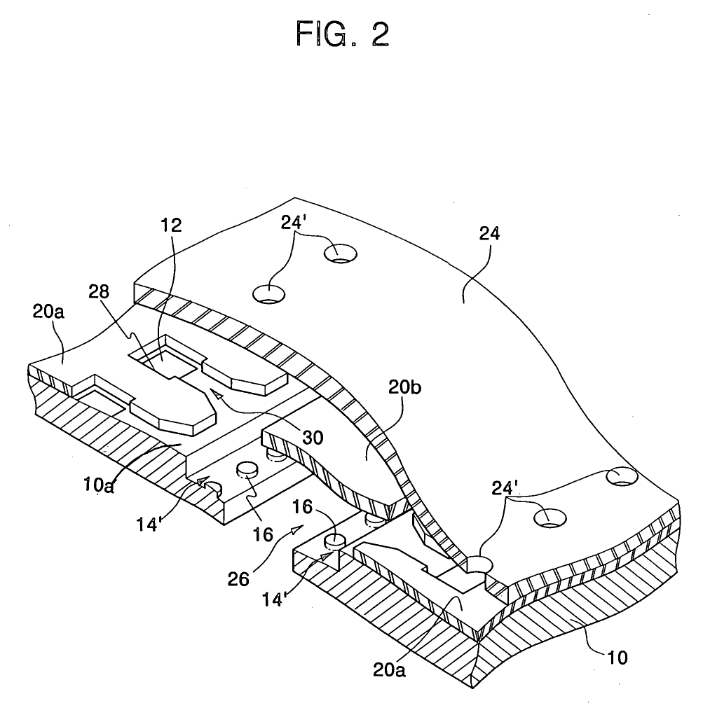

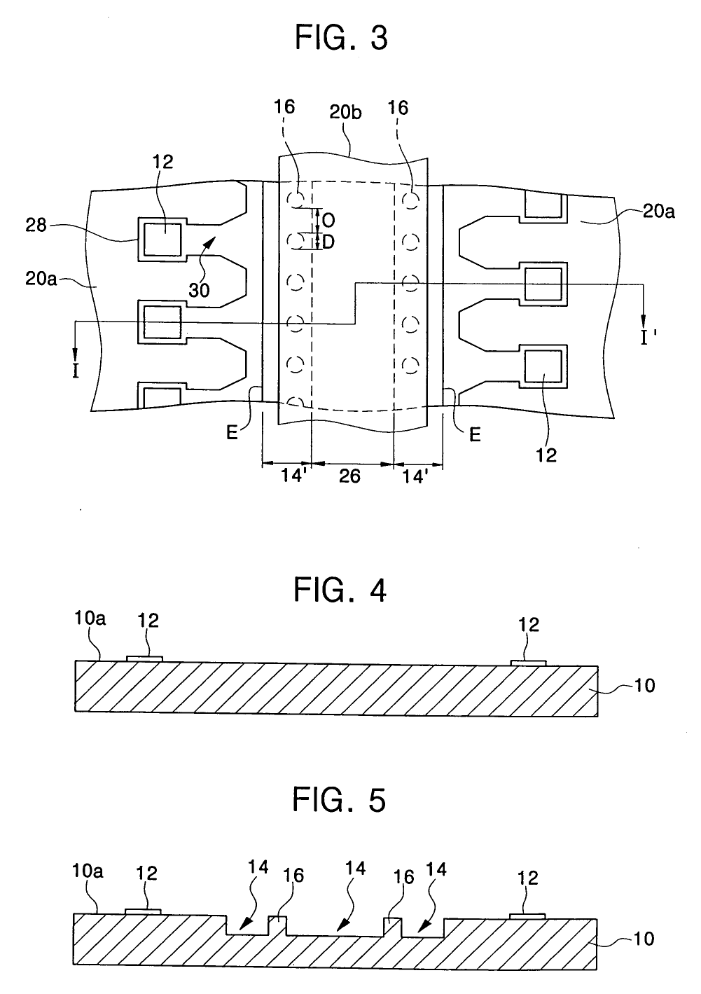

FIG. 2 is a perspective view of an ink jet head in accordance with an embodiment of the present general inventive concept, and FIG. 3 is a plan view of the ink jet head shown in FIG. 2. In addition, FIGS. 4 to 9 are cross-sectional views, taken along the line I-I′ of FIG. 3, illustrating a method of fabricating an ink jet head in accordance with an embodiment of the present general inventive concept.

First, an ink jet head in accordance with an embodiment of the present general inventive concept will be described with reference to FIGS. 2, 3, and 9.

Referring to FIGS. 2, 3, and 9, pressure-generating elements are disposed on a top surface 10a of a substrate 10. The substrate 10 may be a silicon substrate used in a semiconductor manufacturing process having a thickness of about 500 μm. The pressure-generating elements generate pressure to provide ink ejection. In accordance with embodiments of the present general inventive concept, the pressure-generating elements may be heat-generating resistors 12 provided as an electro-thermal transducer. The heat-generating resistors 12 may be made of a high resistance metal such as tantalum or tungsten, an alloy such as tantalum aluminum including the high resistance metal, or poly-silicon having impurity ions doped therein. In addition, while not shown in the drawings, other elements may also be disposed on the top surface 10a of the substrate 10 including, among the other elements, wiring to supply electric signals to the heat-generating resistors 12, conductive pads to electrically connect the heat-generating resistors 12 with an external circuit, a silicon oxide heat barrier formed at a lowermost layer on the substrate 10, and a passivation layer formed to protect structures disposed on the substrate 10.

An ink feed passage 26 extends through the substrate 10. The ink-feed passage 26 may be spaced apart from the heat-generating resistors 12 to extend through a middle portion of the substrate 10. In addition, the ink-feed passage 26 may have a slot shape, when viewed from a plan view. The heat-generating resistors 12 may be arranged in two rows on both sides of the ink-feed passage 26 along a longitudinal direction of the ink-feed passage 26. A manifold 14′, which is recessed from the top surface 10a by a predetermined depth and has a width defined by the ink-feed passage 26, is disposed between the ink-feed passage 26 and the heat-generating resistors 12. As mentioned above, when the ink-feed passage 26 has a slot shape, the manifold 14′ may be disposed along the longitudinal direction of the ink-feed passage 26. A plurality of filtering pillars 16 is disposed on a bottom surface of the manifold 14′. The filtering pillars 16 are integrally formed with the substrate 10. The filtering pillars 16 may be formed by etching the substrate 10. In this case, an etched portion of the substrate 10 is formed into the manifold 14′. Therefore, the filtering pillars 16 have a height substantially equal to a depth of the manifold 14′ from the top surface 10a of the substrate 10. The filtering pillars 16 may be disposed on the manifold 14′ and spaced apart at the same interval, thereby providing filter openings O having the same dimension therebetween.

A flow path structure defining a flow path is disposed on the top surface 10a of the substrate 10. The flow path includes ink chambers 28 that contain the heat-generating resistors 12 therein, ink channels 30 that open the ink chambers 28 toward a direction of the manifold 14′, and nozzles 24′ that are in fluid communication with the ink chambers 28. The flow path structure may include a chamber layer 20a, a cover layer 20b and a nozzle layer 24. The chamber layer 20a is disposed on the top surface 10a of the substrate 10 to define sidewalls of both the ink chambers 28 and the ink channels 30. A cover layer 20b may be disposed at the same level as the chamber layer 20a to be in contact with the top surface of the filtering pillars 16 and to cover the ink-feed passage 26. In addition, the cover layer 20b is sufficiently spaced apart from edges E of the manifold 14′, located at both sides of the ink channel 30, so that the ink supplied from an ink container (not shown) flows smoothly into the flow path through the ink-feed passage 26. The chamber layer 20a and the cover layer 20b may be formed by the same process and of the same material layer. For example, the chamber layer 20a and the cover layer 20b may be a photosensitive resin layer. The nozzle layer 24 is disposed on the chamber layer 20a and the cover layer 20b, and nozzles 24′ extend through the nozzle layer 24 to correspond to the heat-generating resistors 12, respectively.

The ink supplied from the ink container sequentially passes through the ink-feed passage 26, the filter openings O provided by the filtering pillars 16, and the ink channel 30 to be temporarily stored in the ink chambers 28. In this process, in order for the filtering pillars 16 to filter particles in the ink, the filter openings O can have a dimension that is smaller than a minimum dimension of the flow path including the ink channel 30, the ink chamber 28, and the nozzles 24′. The dimension of the filter openings O may be defined as a width of the filter openings O, i.e., a gap between the filtering pillars 16. Therefore, the width of the filter openings O has a dimension smaller than the minimum dimension of the flow path. This allows any particles large enough to clog a part of the flow path having the minimum dimension to be filtered by the filtering pillars 16. Typically, the minimum dimension of the flow path may be a diameter of the nozzles 24′. In addition, the height of the filtering pillars 16 may be substantially equal to a thickness of the chamber layer 20a, i.e., a height of the ink chambers 28.

The filtering pillars 16 may act as a fluid resistor impeding flow of the ink. The dimension of the filtering pillars 16 may be reduced in order to minimize a fluid resistance created by the filtering pillars 16. The filtering pillars 16 may each have the same diameter D and may have the same height extending along an axis perpendicular to a moving direction of the ink. If the widths of the filter openings O, i.e., the gap between the filtering pillars 16, are maintained while increasing the aspect ratio of the filtering pillars 16 by reducing their diameter D, a sum of the widths of all the filter openings O may be increased to minimize the fluid resistance created by the filtering pillars 16.

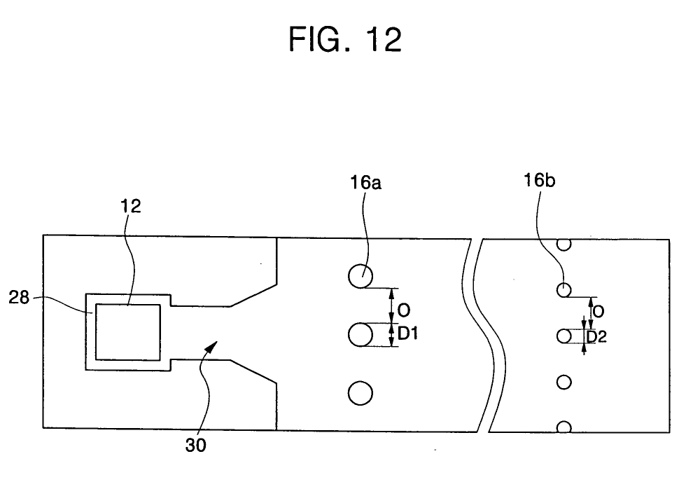

FIG. 12 is a plan view illustrating a relationship of a diameter of filtering pillars and filter openings.

Referring to FIG. 12, when filtering pillars 16a having a first diameter D1 and filtering pillars 16b having a second diameter D2 that is smaller than the first diameter D1 are disposed to provide the filter openings O having the same width, the sum of the widths of all the filter openings O provided by the filtering pillars 16b having the second diameter D2 is increased. For example, when the filtering pillars having a diameter of 10 micrometers (μm) are disposed to provide filter openings having a width of 10 μm on a manifold having a length of 300 μm, the sum of the widths of all the filter openings becomes 150 μm. On the other hand, when the filtering pillars have a diameter of 5 μm, the sum of the widths of all the filter openings becomes 200 μm.

Still referring to FIGS. 2, 3, and 9, since the filtering pillars 16 in accordance with the present general inventive concept are integrally formed with the substrate 10, problems associated with adhesion of the filtering pillars 16 to the top surface 10a of the substrate 10 may be alleviated. In addition, although forming the filtering pillars 16 by etching the substrate results in an aspect ratio greater than 1, the filtering pillars 16 may be reliably formed. Therefore, it becomes possible to minimize the fluid resistance created by the filtering pillars 16 since the filter openings O can be made wider on the manifold 14′. In addition, as the fluid resistance approaches a minimum, a speed of the ink refilled into the ink chambers 28 after the ink ejection is increased, and an ink ejection frequency is improved.

Hereinafter, a method of fabricating an ink jet head in accordance with an embodiment of the present general inventive concept will be described.

Referring to FIGS. 3 and 4, a substrate 10 is prepared. A plurality of pressure-generating elements to generate pressure to provide ink ejection is formed on a top surface 10a of the substrate 10. The pressure-generating elements may be heat-generating resistors 12 made of a high resistance metal such as tantalum or tungsten, an alloy such as tantalum aluminum including the high resistance metal, or poly-silicon having impurity ions doped therein. Other elements may also be formed on the top surface 10a of the substrate including, among other elements, wiring to supply electric signals to the heat-generating resistors 12, conductive pads to electrically connect the heat-generating resistors 12 with an external circuit, a silicon oxide heat barrier formed at the lowermost layer on the substrate 10, and a passivation layer formed to protect structures disposed on the substrate 10.

Referring to FIGS. 3 and 5, the substrate 10 is patterned to form a trench 14 at a middle portion of the substrate 10 spaced apart from the heat-generating resistors 12. More specifically, a mask pattern (not shown) is formed on the substrate 10, and the substrate 10 is etched by a predetermined depth using the mask pattern as an etch mask. As a result, the trench 14 is formed to define the plurality of filtering pillars 16 at the middle portion of the substrate 10. The filtering pillars 16 are portions masked by the mask pattern. The depth of the trench 14, i.e., the height of the filtering pillars 16, is substantially equal to the thickness of a chamber layer, which is to be formed by the following process. In addition, the filtering pillars 16 are formed to be spaced apart from a sidewall of the trench 14 and to be spaced apart from each other at the same interval along the sidewall of the trench 14, thereby providing the filter openings O having the same width between the filtering pillars 16. The filtering pillars 16 are formed to have an aspect ratio greater than about 1, and the aspect ratio of the filtering pillars 16 has a proportional relationship with the sum of the widths of all the filter openings O. Conversely, the diameter D of the filtering pillars 16 has a relationship that is inversely proportional to the sum of the widths of all the filter openings O.

In accordance with various embodiments of the present general inventive concept, the substrate 10 may be etched by a reactive ion etching (RIE) process or a deep reactive ion etching (DRIE) process. The DRIE process is also known as an inductive coupled plasma (ICP) process. In particular, the DRIE process may form the filtering pillars 16 having a high aspect ratio by using a high-density plasma source and alternately performing the etching and the passivation layer deposition. In this case, SF₆ gas may be used as an etching plasma source, and C₄F₈ gas may be used as a passivating plasma source.

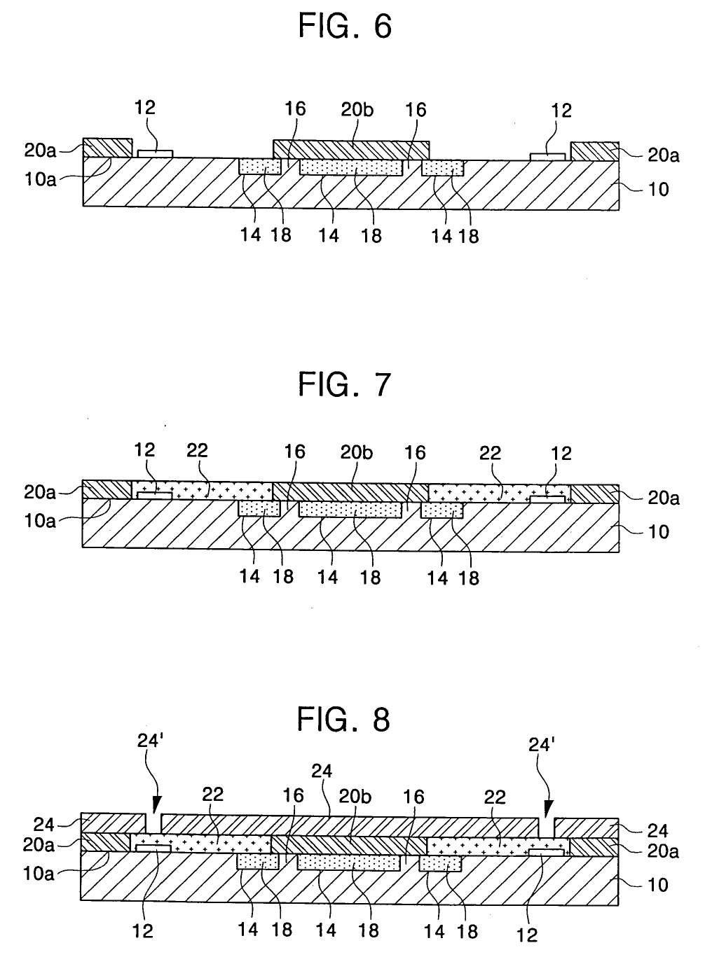

Referring to FIGS. 3 and 6, after removing the mask pattern, a lower sacrificial layer 18 is formed to fill the trench 14. The lower sacrificial layer 18 may be formed of a polyimid-based or polyamide-based positive photosensitive resin layer or a thermoplastic resin layer formed by a spin coating method. A chamber layer 20a and a cover layer 20b are formed on the substrate 10 having the lower sacrificial layer 18. The cover layer 20b is formed to cover the filtering pillars 16 and is spaced apart from the sidewalls of the trench 14. The chamber layer 20a and the cover layer 20b may be formed by forming a photosensitive resin layer on the top surface 10a of the substrate 10 and then exposing and developing the photosensitive resin layer. The photosensitive resin layer may be formed by the spin coating method using a liquid photosensitive resin, or by hot-pressing a photosensitive dry film layer by a lamination method. When using the dry film layer, the process of forming the lower sacrificial layer 18 may be omitted.

Referring to FIGS. 3 and 7, an upper sacrificial layer 22 is formed to fill a space between the chamber layer 20a and the cover layer 20b. The upper sacrificial layer 22 may be formed of a polyimid-based or polyamide-based positive photosensitive resin layer or a thermoplastic resin layer similar to the lower sacrificial layer 18. Alternatively, the process of forming the chamber layer 20a and the cover layer 20b described in FIG. 6 may be performed after the process of forming the upper sacrificial layer 22 described in FIG. 7. That is, after forming the lower sacrificial layer 18, the upper sacrificial layer 22 may be formed on the substrate 10 to cover a region at which a flow path is to be formed. The chamber layer 20a and the cover layer 20b may then be formed.

Referring to FIGS. 3 and 8, a nozzle layer 24 having nozzles 24′ corresponding to each of the heat-generating resistors 12 is formed on the chamber layer 20a, the cover layer 20b, and the upper sacrificial layer 22. The nozzle layer 24 may be formed by forming a photosensitive resin layer on the chamber layer 20a, the cover layer 20b, and the upper sacrificial layer 22, and then exposing and developing the photosensitive resin layer. The photosensitive resin layer may be formed by a spin coating method using a liquid photosensitive resin, or by hot-pressing a photosensitive dry film layer by a lamination method. When using the dry film layer, the process of forming the upper sacrificial layer 22 may be omitted.

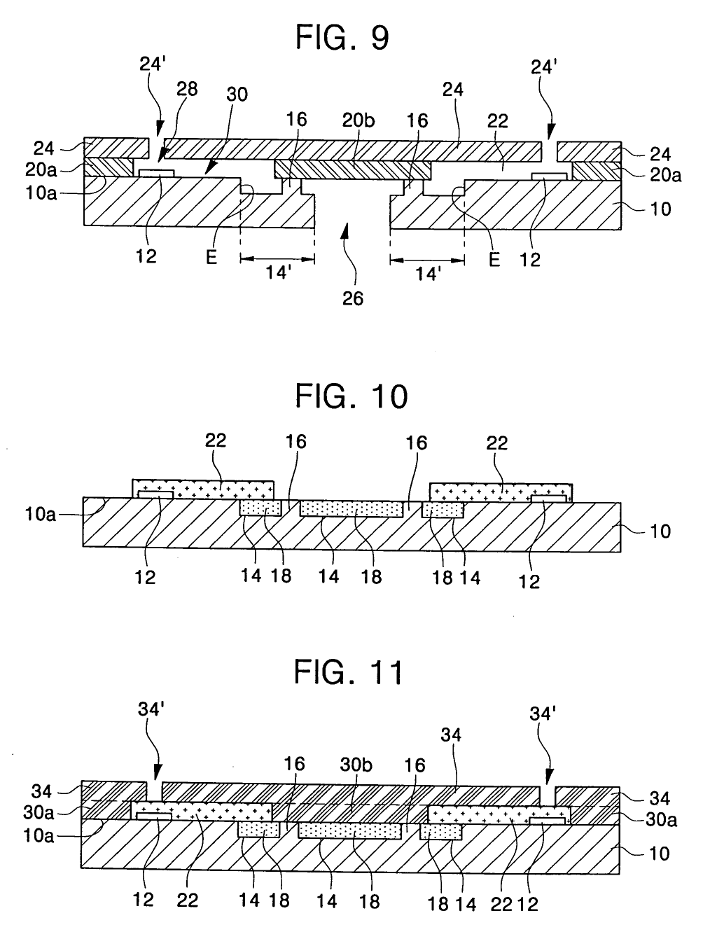

Referring to FIGS. 3 and 9, after forming the nozzle layer 24, the substrate 10 at a bottom portion of the trench 14 is etched to form an ink-feed passage 26. The ink-feed passage 26 may be formed by a dry etching method such as an RIE process or a sandblasting process, or a wet etching method using a strong alkaline solution such as tetramethyl ammonium hydroxide (TMAH) as an etchant. The manifolds 14′ including the filtering pillars 16 are defined at side portions of the trench 14 by forming the ink-feed passage 26. That is, the manifolds 14′ have a width defined by the ink-feed passage 26. Once the ink feed passage 26 is formed, the lower and upper sacrificial layers 18 and 22 are removed by an appropriate solvent, for example, glycol ether, methyl lactate, or ethyl lactate. As a result, the ink chambers 28 and the ink channels 30 are formed at a region from which the upper sacrificial layer 22 is removed. In accordance with an embodiment of the present general inventive concept, the chamber layer 20a, the cover layer 20b, and the nozzle layer 24 configure a flow path structure to define the ink chambers 28, the ink channels 30, and the nozzles 24′.

FIGS. 10 and 11 are cross-sectional views illustrating a method of fabricating an ink jet head in accordance with another embodiment of the present general inventive concept.

Referring to FIG. 10, after forming a trench 14 to define the filtering pillars 16 by performing the processes described in FIGS. 4 and 5, a lower sacrificial layer 18 is formed to fill the trench 14. Then, an upper sacrificial layer 22 is formed on the substrate 10 to cover a region at which a flow path is to be formed.

Referring to FIG. 11, a flow path material layer (not shown) is formed on the substrate 10 to cover the upper sacrificial layer 22, the substrate 10, and the lower sacrificial layer 18. The flow path material layer is formed to fill a space between parts of the upper sacrificial layer 22, and to have a predetermined thickness from a top surface of the upper sacrificial layer 22. The flow path material layer may be formed of a photosensitive resin layer. The flow path material layer is then patterned to form a flow path structure having nozzles 34′ corresponding to each of the heat-generating resistors 12. Thus, in accordance with the present embodiment, a flow path structure including a chamber layer 30a, a cover layer 30b and a nozzle layer 34 may be integrally formed by the same process. After forming the flow path structure, the process as described in FIG. 9 is performed to form an ink-feed passage.

### EXAMPLES

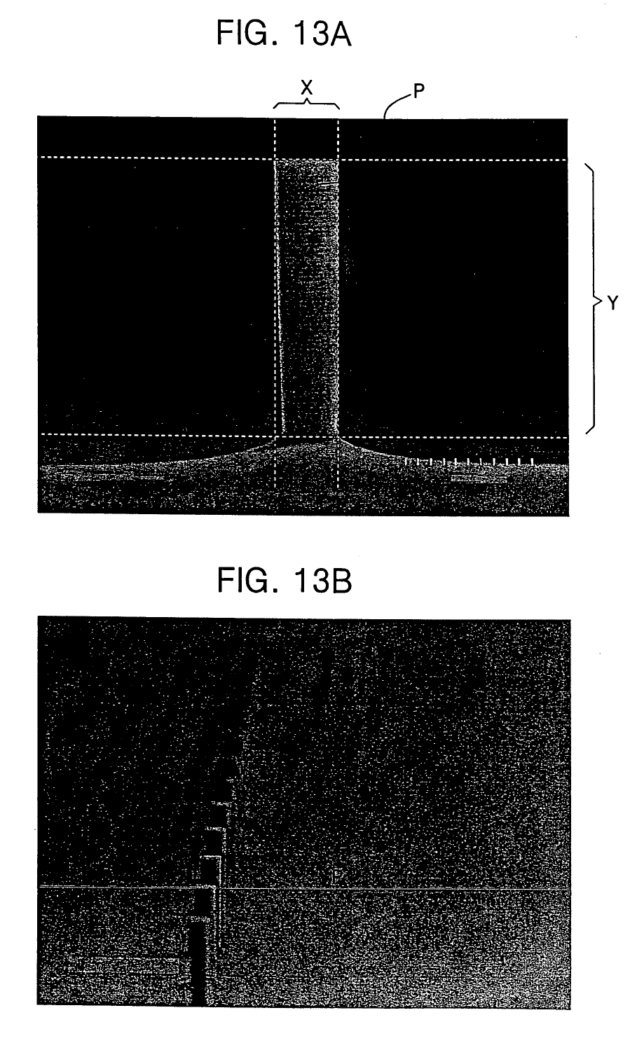

FIGS. 13A and 13B are SEM images depicting filtering pillars P in accordance with embodiments of the present general inventive concept. The filtering pillars are formed by forming a photo-resist pattern to cover a region, at which the filtering pillars are to be formed, on a silicon substrate, and then etching the silicon substrate using the photo-resist pattern as an etch mask. The silicon substrate is then dry etched using a DRIE process. The filtering pillars P are formed to have a width X of about 5 micrometers (μm), and a height Y of about 20 μm, thereby having an aspect ratio of about 4. In addition, the filtering pillars P are formed to have a gap (i.e., filter opening) of about 10 μm.

Referring to FIGS. 13A and 13B, and in accordance with embodiments of the present general inventive concept, when the silicon substrate is dry etched to form the filtering pillars P, the filtering pillars P are formed to have a high aspect ratio. Even though the filtering pillars P have a high aspect ratio, the filtering pillars P are capable of embodying a firm and reliable particle filtering system since the filtering pillars P are formed integrally with the substrate and thereafter will not be separated therefrom.

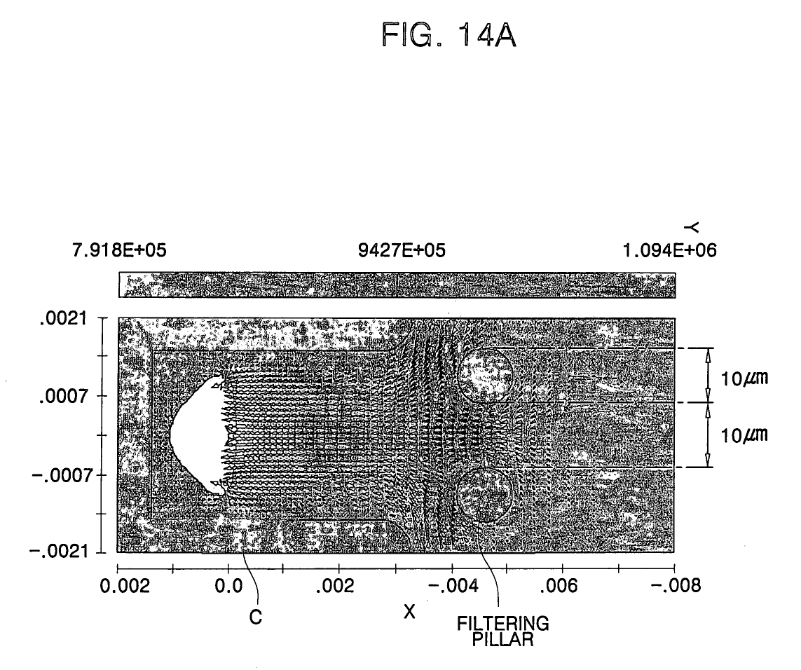

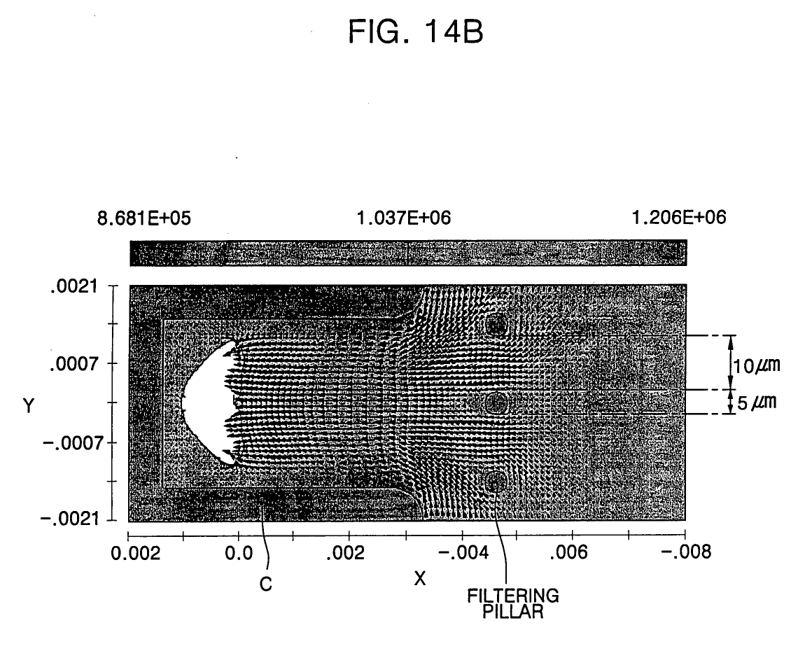

FIGS. 14A and 14B are views representing computer simulation results to estimate ink ejection properties of an ink jet head depending upon a dimension of filtering pillars. In FIGS. 14A and 14B, ink chambers C are designed to have a three-sided barrier structure. In addition, the filtering pillars are designed to have a diameter of about 10 μm and 5 μm, respectively, and a gap between the pillars, i.e., a width of filter openings of about 10 μm. FIGS. 14A and 14B are views that represent results seven seconds after the ink ejection.

Referring to FIGS. 14A and 14B, when the filtering pillars have a diameter of about 5 μm, it appears that the ink is introduced into the ink chambers C after the ink ejection more rapidly than when the filtering pillars have a diameter of about 10 μm. In addition, an ink ejection frequency is calculated to have values of about 72 KHz and 59 KHz when the filtering pillars have diameters of about 5 μm and 10 μm, respectively. The reason for these results is that the sum of the widths of all the filter openings is increased by providing more filter openings, when the filtering pillars have a diameter of about 5 μm.

The filtering pillars in accordance with embodiments of the present general inventive concept are integrally formed with the substrate by etching the substrate. Therefore, although the filtering pillars have a high aspect ratio, the filtering pillars can be reliably formed to provide many filter openings in the flow path having a restricted dimension. As a result, deterioration of ink ejection properties can be minimized by not only minimizing the fluid resistance, but also by preventing particles from clogging the flow path.

As can be seen from the foregoing, the substrate is etched to form the filtering pillars integrally formed with the substrate. Although the filtering pillars have a high aspect ratio, the filtering pillars are strongly and reliably formed on the substrate. As a result, the present general inventive concept is capable of improving properties of an ink jet head by not only minimizing a fluid resistance but also by preventing foreign materials from penetrating into the flow path.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink jet head comprising:
a plurality of pressure-generating elements disposed on a substrate to generate pressure to provide ink ejection;
an ink-feed passage spaced apart from the pressure-generating elements and extending through the substrate;
a manifold disposed between the pressure-generating elements and the ink-feed passage, recessed from a top surface of the substrate by a predetermined depth, and having a width defined by the ink-feed passage;
a plurality of filtering pillars disposed on a bottom surface of the manifold to provide filter openings therebetween, the filtering pillars being integrally formed with the substrate; and
a flow path structure disposed on the substrate, and defining a flow path, the flow path including ink chambers that contain the pressure-generating elements therein, ink channels that open the ink chambers toward a direction of the manifold, and nozzles that are in fluid communication with the ink chambers.

2. The ink jet head according to claim 1, wherein the substrate is a silicon substrate.

3. The ink jet head according to claim 1, wherein the manifold has a depth equal to a height of the filtering pillars.

4. The ink jet head according to claim 3, wherein the filtering pillars have an aspect ratio greater than about 1.

5. The ink jet head according to claim 1, wherein the filter openings have the same dimensions.

6. The ink jet head according to claim 5, wherein the filter openings have dimensions that are smaller than a minimum dimension of the flow path.

7. The ink jet head according to claim 1, wherein the ink-feed passage has a slot shape extending through a middle portion of the substrate, and the manifold is disposed along a longitudinal direction of the ink-feed passage.

8. The ink jet head according to claim 1, wherein the flow path structure comprises:
a chamber layer defining sidewalls of the ink chamber and the ink channel;
a nozzle layer in contact with a top surface of the chamber layer and having the nozzles extending therethrough; and
a cover layer disposed at the same level as the chamber layer in contact with a top surface of the filtering pillars and to cover the ink-feed passage, and a top surface of the cover layer contacting a lower surface of the nozzle layer.

9. The ink jet head according to claim 8, wherein the chamber layer and the cover layer are made of the same material layer.

10. The ink jet head according to claim 9, wherein the chamber layer and the cover layer are made of a photosensitive resin layer.

11. An ink jet head comprising:
a substrate with a plurality of pressure generating elements disposed thereon to generate pressure to eject ink;
an ink-feed passage extending through the substrate along a longitudinal direction;
an ink flow path structure disposed on the substrate to define an ink flow path to supply ink from the ink-feed passage to the pressure generating elements; and
a filtering member formed integrally with the substrate at an area where the ink-feed passage meets the ink flow path and having a plurality of filter openings.

12. The ink jet head according to claim 11, wherein the filter openings are smaller than a minimum dimension of the ink flow path so that particles that are larger than a minimum dimension of the flow path are filtered by the filtering member.

13. The ink jet head according to claim 11, wherein the ink flow path structure includes a chamber layer that defines ink chambers having the pressure generating elements therein, and a nozzle layer that defines nozzles corresponding to the pressure generating elements and being in fluid communication with the ink chambers.

14. The ink jet head according to claim 11, wherein the substrate is silicon and the filtering member is formed by etching the silicon substrate.

15. The ink jet head according to claim 11, wherein the filtering member further comprises:
a manifold disposed between the pressure generating elements and on both sides of the ink-feed passage extending in the longitudinal direction and recessed from a top level of the substrate by a predetermined depth; and
a plurality of filtering pillars disposed on a surface of the manifold in at least two rows extending in the longitudinal direction along opposite sides of the ink-feed passage and creating the filter openings therebetween.

16. The ink jet head according to claim 15, wherein the filtering pillars have an aspect ratio between 1 and 4.

17. The ink jet head according to claim 15, wherein the filtering pillars have a diameter between 5 micrometers and 10 micrometers.

18. The ink jet head according to claim 15, wherein the filtering pillars have a predetermined height that is substantially equal to the predetermined depth.

19. The ink jet head according to claim 15, wherein the filtering member further comprises:
a cover layer disposed on top surfaces of the at least two rows to cover the ink-feed passage and the filtering pillars and to be spaced apart from sidewalls of the manifold so that ink smoothly flows from the ink-feed passage through the filtering member into the ink flow path.

20. An inkjet head comprising:
a substrate including a plurality of pressure generating elements disposed thereon to create a pressure to eject ink and an opening to receive the ink;
an ink flow path structure including nozzles associated with the pressure generating elements and disposed on the substrate to define an ink flow path to supply the received ink to the pressure generating elements to eject the ink through the nozzles; and
a filtering member formed integrally with the substrate between the ink flow path and the opening in the substrate and having filter openings.

21. The ink jet head according to claim 20, wherein the filter openings are smaller than a minimum dimension of the ink flow path so that particles that are larger than a minimum dimension of the flow path are filtered by the filtering member.

22. The inkjet according to claim 20, wherein the filtering member is formed by etching the substrate.

23. The ink jet head according to claim 20, wherein the filtering member further comprises:
a manifold disposed between the pressure generating elements and on both sides of the opening in the substrate extending in a longitudinal direction and recessed from a top level of the substrate by a predetermined depth; and
a plurality of filtering pillars disposed on a surface of the manifold in at least two rows extending in the longitudinal direction along opposite sides of the opening in the substrate and creating the filter openings therebetween.

24. The ink jet head according to claim 20, wherein the filtering pillars have an aspect ratio between 1 and 4.

25. The ink jet head according to claim 20, wherein the filtering pillars have a diameter between 5 micrometers and 10 micrometers.

26. The ink jet head according to claim 20, wherein the filtering pillars have a predetermined height that is substantially equal to the predetermined depth.

27. A method of fabricating an ink jet head, the method comprising:
forming a plurality of pressure-generating elements to generate pressure to provide ink ejection on a substrate;
patterning the substrate to form a trench spaced apart from the pressure-generating elements and defining a plurality of filtering pillars, the filtering pillars being spaced apart from sidewalls of the trench by a predetermined distance and being formed to provide filter openings therebetween;
forming a flow path structure defining a flow path on the substrate having the filtering pillars, the flow path including ink chambers that contain the pressure-generating elements therein, ink channels that open the ink chambers toward a direction of the trench, and nozzles that are in fluid communication with the ink chambers; and
etching the substrate to form an ink-feed passage extending through a bottom of the trench and to define a manifold including the filtering pillars.

28. The method according to claim 27, wherein patterning the substrate includes dry etching the substrate.

29. The method according to claim 28, wherein dry etching the substrate is performed using one of a reactive ion etching (RIE) process and a deep reactive ion etching (DRIE) process.

30. The method according to claim 27, wherein the filtering pillars are formed to have an aspect ratio greater than about 1.

31. The method according to claim 27, wherein the filter openings provided by the filtering pillars have the same dimensions.

32. The method according to claim 31, wherein the filter openings have dimensions that are smaller than a minimum dimension of the flow path.

33. The method according to claim 27, wherein forming the flow path structure further comprises:
forming a chamber layer defining sidewalls of the ink chambers and the ink channels on the substrate, and forming a cover layer covering a top surface of the filtering pillars and a middle portion of the trench; and
forming a nozzle layer including nozzles which are in fluid communication with the ink chambers in the chamber layer and the cover layer.

34. The method according to claim 33, wherein the chamber layer and the cover layer are made of a photosensitive resin layer.

35. The method according to claim 33, further comprising forming a lower sacrificial layer to fill the trench, before forming the chamber layer and the cover layer.

36. The method according to claim 35, further comprising forming an upper sacrificial layer to fill a space between the chamber layer and the cover layer, before forming the nozzle layer.

37. The method according to claim 35, further comprising forming an upper sacrificial layer on the substrate to cover a region, at which an flow path is to be formed, on the substrate, between forming the lower sacrificial layer and forming the chamber layer and the cover layer.

38. A method of fabricating an ink jet head, the method comprising:
providing a substrate having at least two rows of pressure-generating elements disposed along a longitudinal direction;
etching the substrate to form a trench extending along the longitudinal direction in between the at least two rows of pressure generating elements, and the trench having a plurality of filtering pillars disposed in at least two rows that extend in the longitudinal direction along opposite sides of the trench, wherein the filtering pillars in the at least two rows form filter openings having a predetermined width;
forming an ink flow path structure on the substrate to define an ink flow path that supplies ink to the pressure generating elements and to be in fluid communication with the trench; and
forming an ink-feed passage to extend through the substrate in the longitudinal direction in between the at least two rows of filtering pillars such that the filter openings act as a filter to ink supplied to the ink flow path from the ink-feed passage.

39. The method according to claim 38, wherein the forming of the ink flow path structure comprises:
forming a cover layer to contact top surfaces of the at least two rows of filtering pillars and to extend over a portion of the trench on both sides of the at least two rows of filtering pillars so that ink supplied by the ink feed passage must pass between one of the filter openings in order to be supplied to the ink flow path.

40. The method according to claim 38, wherein forming an ink flow path structure further comprises:
forming a chamber layer to define sidewalls of ink flow chambers having the pressure generating elements disposed therein;
forming a nozzle layer to define the ink flow channels that supply ink to the ink chambers and the nozzles that correspond to the pressure generating elements and are in fluid communication with the ink chambers.

41. The method according to claim 38, further comprising:
before forming the ink flow path structure, forming a first sacrificial layer to fill the trench and an area around the filtering pillars.

42. The method according to claim 41, wherein forming the ink flow path structure further comprises forming a chamber layer to define sidewalls of ink chambers having the pressure generating elements therein, to cover the filtering pillars and extend over a portion of the trench, and to define sidewalls of ink flow channels.

43. The method according to claim 42 wherein forming the ink flow path structure further comprises, after forming the chamber layer, forming a nozzle layer having nozzles that correspond to the pressure generating elements.

44. The method according to claim 38, wherein the ink flow path has a minimum dimension and the filter openings are formed to be smaller than a minimum dimension.

45. The method according to claim 38, wherein the filtering pillars are formed to have an aspect ratio greater than 1.

46. The method according to claim 38, further comprising:
before forming the ink flow path structure, forming a first sacrificial layer to fill a space in the trench around the filtering pillars;
forming a second sacrificial layer to fill a region at which the ink flow path is to be formed.

47. The method according to claim 46, wherein forming the ink flow path structure further comprises forming a flow path material layer on the substrate over the second sacrificial layer such that the flow path material layer comprises a chamber layer that covers the at least two rows of filtering pillars, defines ink flow chambers having pressure generating elements therein, and defines ink flow channels to provide ink from the filter openings to the ink chambers; and a nozzle layer with nozzles that correspond to the pressure-generating elements.
